(19) United States
(12) Patent Application Publication
(10) Pub. No.: US 2016/0271869 A1
(43) Pub. Date: Sep. 22, 2016

(54) DEVICE FOR PRINTING A THREE-DIMENSIONAL STRUCTURE

(71) Applicant: LUXEXCEL HOLDING B.V., Kruiningen (NL)

(72) Inventors: Richard Van De Vrie, Wolphaartsdijk (NL); Joris Biskop, Vlissingen (NL); Ricardo Blomaard, Goes (NL)

(21) Appl. No.: 15/029,477

(22) PCT Filed: Oct. 13, 2014
(86) PCT No.: PCT/EP2014/071830

§ 371 Date: Apr. 14, 2016

(30) Foreign Application Priority Data
Oct. 17, 2013 (EP) 13189085.7

(51) Int. Cl. B29C 67/00

(52) U.S. Cl. CPC B29C 67/007; B29C 67/0059; B29C 67/0088; B29C 67/0085; B33Y 10/00

(57) ABSTRACT

The present invention suggest a device (1) for printing a three-dimensional structure (2) by depositing droplets of printing material onto a substrate (3), wherein the device (1) for printing a three-dimensional structure (2) comprises a locally fixed framework (10) and a mean for moving the substrate (11), wherein the locally fixed framework comprises a printing mean (20) for depositing the droplets onto the substrate and the mean for moving the substrate is configured such that the substrate is movable relative to the locally fixed framework.

### BACKGROUND

The present invention relates to a device for printing three-dimensional structures, wherein droplets of printing material are deposited onto a substrate. Such devices comprise usually a printing head that ejects droplets, wherein the printing head scans the substrate several times in order to build up the three-dimensional structure layer by layer.

The success of such devices for printing three-dimensional structures, namely 3D-printer, motivates to upgrade those with respect to efficiency, flexibility, safety and costs. In this context it is also desirable to decrease the amount of energy needed for using a 3D-printer or increase the number of three-dimensional structures that can be produced using one 3D-printer, for example. Moreover a device for printing a three-dimensional structure should also fulfill safety requirements and protect objects and persons from damage that could be caused by at least one component of the 3D-printer, in particular the UV-light usually used for curing the deposited droplets. It is also desirable to improve the quality of the produced three-dimensional structure. In particular improvements could be related to the accuracy of depositing droplets onto the substrate during the printing process. Inaccuracies may raise from deviations in the absolute positional accuracy of the print head caused by movement changes that accumulate and lead to increasing errors in droplet positions in the end of the printing progress, for instance.

### SUMMARY

It is therefore an object of the present invention to improve the quality of the produced three-dimensional structure by providing a device for printing three-dimensional structures that deposits droplets of printing material more precisely than those known from the state of the art. Moreover it is desirable to realize a device for printing three-dimensional structures that can adapted easily to the requirements of the individual printing process.

The object is solved by a device for printing a three-dimensional structure by depositing droplets of printing material onto a substrate, wherein the device for printing a three-dimensional structure comprises a locally fixed framework and a mean for moving the substrate, wherein the locally fixed framework comprises a printing mean for depositing the droplets onto the substrate and the mean for moving the substrate is configured such that the substrate is movable relative to the locally fixed framework. For example the printing mean comprises a print head, i.e. nozzles for depositing droplets of printing material.

It is herewith advantageously possible to improve the accuracy of positioning the droplets onto the substrate compared to those known from the state of the art. Using the device for printing the three-dimensional structure according to the present invention enables determination of the position of the deposited droplets, i. e. the positioning of the deposited droplets, by changing the position of the substrate with respect to the printing mean mainly. As a result deviations of the print mean position caused by movement changes cannot accumulate and consequently the accuracy of positioning the deposited droplets is improved. It is also conceivable that the position of the substrate is monitored by a detection mean and subsequently the position of the substrate is corrected as soon as the current position of the substrate deviates from the position the substrate should have. In particular it is provided that the device is configured such that the three-dimensional structure is realized after a single pass of the substrate with respect to the printing mean. In such a scenario it is another advantage that a produced defect does not affect the subsequent printing process compared to a device that produces the three-dimensional structure layer by layer and therefore the shape of the layer depends on the shape of the previous layer, in particular on potential defect produced by forming the previous layer. In particular it is provided that the locally fixed framework is constructed as an arch, covering the region at which the printing process takes place. Thus the locally fixed framework protects the printing process from being affected by surroundings at least partially. It is also conceivable that the locally fixed framework is tube like shaped and the printing mean is arranged inside the tube surrounding the substrate. Preferably the mean for moving the substrate comprise a plate, wherein the substrate is arranged on top of the plate during the printing process. Provided that the three-dimensional structure is removed from the substrate after the printing process, the substrate may be permanently fixed to the mean for moving the substrate. In particular the plate comprises vacuum micropores and/or a ceramic plate. Moreover it is provided that the means for moving the substrate comprise guiding means that support accurate positioning of the substrate during the printing process. For instance stoppers, rollers and/or a rail system are arranged on the plate provided for positioning the substrate precisely.

According to a preferred embodiment of the present invention it is provided that the substrate has a main plane and the mean for moving the substrate is configured such that the substrate is movable
in a transport direction for passing the printing mean and/or
in a printing direction for realizing at least a part of the three-dimensional structure, wherein the transport direction and the printing direction are parallel to the main plane. It is herewith advantageously possible to orientate the substrate such that each location of the substrate can be used for depositing the droplets. In particular it is provided that the substrate is greater than the printing mean, in particular greater in a direction parallel to the main plane of the substrate. As a result of the movement (in two directions) it is advantageously possible to realize a three-dimensional structure independent of the size of the printing mean that may limit the dimensions of the three-dimensional structure otherwise. Another advantage is that additional cost caused by a huge printing mean may be avoided.

According to a preferred embodiment of the present invention it is provided that the printing mean is arranged to the locally fixed framework such that the distance between the substrate and the printing mean is variable. As a result the accuracy of positing the droplets is further improved whenever the distance between the substrate and the printing mean is reduced during the depositing process. Advantageously the deposited particles may be distributed over a smaller area or region compared to deposited particles distributed by a printing head being more distanced from the substrate.

According to a preferred embodiment of the present invention t it is provided that the means for moving the substrate and/or the printing head are configured such that the mean for moving the substrate and/or the printing head causes or determinates the positioning of the droplets deposited onto the substrate. In particular the mean for moving the substrate is configured to move the substrate to that position relative to the printing mean along the printing direction, which is provided for depositing the droplets of printing material. In particular it is provided that the printing mean moves slowly along the printing direction. It is also thinkable that the movement of the substrate may also be changed in speed in order to generate a layer of printing material having a variable height, provided the number of droplets per time ejected by the printing mean stays constant mainly. It is also thinkable that the movement of the substrate and the movement of the printing means are synchronized in order to realize a desired distribution of droplets on the layer. Thus the device for printing the three-dimensional structure configured according to the present embodiment facilities a plurality of different and individually adapted methods for depositing droplets onto the substrate.

According to a preferred embodiment of the present invention it is provided that the locally fixed framework comprises a tank including printing material, wherein the tank is configured such that the tank supplies the printing mean with printing material and wherein the tank is connected reversibly or interchangeably to the locally fixed framework. Integrating the tank into the locally fixed framework has the advantage of guaranteeing a permanent supply of printing material to the printing mean without moving the tank during the printing process. Consequently it is possible to reduce the amount of energy needed for using the device for printing the three-dimensional structure. Avoiding the movement of the tank during the printing process may particularly advantageous whenever a three-dimensional structure is intended to be generated that needs a big amount of printing material being deposited without interruption of the printing process (maybe caused by refilling or reloading printing material). It is also an advantage that the tank is connected to the locally fixed framework reversibly or interchangeably, since the tank, in particular in dependency of its content or its size, may be replaced by another tank in order to adapt the tank to the printing process. Preferably the tank has a capacity up to 6 liters. It is also thinkable that the fixed framework comprises a plurality of tanks including different printing material respectively. Furthermore it is conceivable that the fixed framework also comprises a premix chamber, wherein the premix chamber is configured such that a first printing material out of a first tank is mixed with a second printing material out of a second tank. It is also thinkable that the second tank includes a material for mixing with the first printing material, wherein the material for mixing with the first printing material changes the properties of the first printing material advantageously. For example the material for mixing dilutes the first printing material. Preferably the printing material in the premix chamber is used for realizing the three-dimensional structure. Moreover the tank or the plurality of tanks is configured such that the printing material is changeable during the printing process. In particular the fixed framework and/or the printing means are designed such that the printing mean is cleaned, in particular the printing mean is cleaned on the flight during the printing process. Moreover it is thinkable that the second tank or a cleaning device mounted to the fixed framework includes a cleaning solution that cleans the printing mean. Moreover it is thinkable that the printing mean comprises a print head and is configured such that the printing material is released from the printing mean permanently in order to avoid a blocking of the nozzles for instance. In particular the substrate comprises a waste tank that collects a part of the printing material that is not intended for creating the three-dimensional structure. Moreover the waste tank is able to recirculate printing material back to the tank or the printing mean for releasing printing material from the printing mean permanently. It is also thinkable that the printing head, which is included in the printing mean, is configured such that the printing material is recirculated inside the print head in order to avoid drying of the printing material inside the printing head. It is also thinkable that the printing material includes particles made from metal. Furthermore the printing mean, in particular the printing head, comprises pumping and/or filtering devices for manipulating the printing material.

According to another embodiment of the present invention it is provided that the tank and/or the printing means are configured such that the droplets of printing material are released from the printing mean with a constant pressure. Consequently the deposition of the droplets of the printing material is substantially reproducible. In particular the tank or the printing mean comprises a device for observing and controlling the pressure. It is also thinkable that a flow of the printing material in the printing mean, in particular in its printing head, is controlled.

According to a preferred embodiment of the present invention it is provided that the framework comprises a light source for curing the deposited droplets of printing material, wherein the light source is connected reversibly or interchangeably to the locally fixed framework. Preferably the light source is provided for curing the deposited droplets and is arranged such that a light cone of the light source is directed to the substrate, in particular to the droplets on the substrate. In particular it is provided that the light sources are arranged such that no light encounters the printing head in order to avoid curing droplets that provided for ejection. Such an arrangement may reduce the probability of blocking a nozzle that is intended for ejecting the droplets of printing material. Due to a reversible connection between the locally fixed framework and the light source the light source is interchangeable and may advantageously adapted to the printing process individually.

According to a preferred embodiment of the present invention it is provided that the mean for moving the substrate is attached to the locally fixed framework. By combining the locally fixed framework and the mean for moving the substrate the probability is reduced that the locally fixed framework and the mean for moving the substrate are shifted to each other. In particular the stability for positioning the substrate relative to the printing head is improved. It is also thinkable that the mean for moving the substrate is connected to the locally fixed framework reversibly or interchangeably. Moreover it is conceivable the mean for moving the substrate is configured such that the substrate rotates about an axis perpendicular to the transport direction. Preferably an angle of rotation of the substrate is between 0° and 90°. In particular the substrate passes the fixed framework several times and after each pass the substrate rotates around a specific angle, for example 90°.

According to another embodiment of the present invention it is provided that the substrate is heated or cooled in order to improve the curing process of the printing material.

According to a preferred embodiment of the present invention it is provided that the device for printing a three-dimensional structure comprises an encapsulation, wherein the encapsulation surrounds at least a part of the locally fixed framework, the means for moving the substrate and/or the substrate, wherein the encapsulation is configured such that light is blocked by the encapsulation. Such an encapsulation may protect the substrate, the printing process the three-dimensional structure, the mean for moving the substrate and/or the device of printing the three-dimensional structure from being affected by surroundings that could interfere with the components of the device for printing the three-dimensional structure. As a result a preferably environment for printing a three-dimensional structure of high quality is provided. Moreover the encapsulation blocks light, in particular UV- or IR-light, and therefore the encapsulation can prevent humans and/or objects from being damaged by UV- or IR-light emitted, reflected and/or scattered from the device for printing the three-dimensional structure advantageously. For this purpose the encapsulation may be coated by a coating, in particular a UV or IR-grade coating, that guarantees blocking the light intended for curing the deposited droplets. It is also conceivable that the encapsulation is coated such that the light is reflected from the wall of the encapsulation to the droplets of printing material on the substrate. The reflected light supports the printing process and the amount of energy for producing the three-dimensional structure is reduced positively. It is also thinkable that printing material is cured by an electron beam and the encapsulation protects the surrounding from the electron beam.

According to a preferred embodiment of the present invention it is provided that the encapsulation forms a cleanroom including the substrate, the locally fixed framework and the means for moving the substrate. Such a cleanroom has the advantage that the printing process is isolated from the surrounding that may affect the printing process negatively. It is also thinkable that the cleanroom is filled with a gas, such as nitrogen or oxygen, that may affect the printing process positively. In particular the dosage of the gas is adjusted such that the curing is accelerated or decelerated. Moreover it is thinkable that the dosage and/or the type of the gas is changed during the printing process. It is also conceivable that the pressure within the cleanroom is adapted to the printing process. In particular it is herewith advantageously possible to adapt easily the parameters of the environment such as temperature, humidity or air pressure to those desired for the printing process individually.

According to a preferred embodiment of the present invention it is provided that the cleanroom comprises a cleaning device that is configured such that the substrate is cleaned before the droplets of printing material are deposited onto the substrate.

According to a preferred embodiment of the present invention it is provided that the printing mean comprises
a nozzle and/or an array of nozzles for depositing the droplets of printing material, i.e. a printing head
a light source for curing the deposited droplets,
a coater for coating the three-dimensional structure and/or
sensor means for controlling the printing process and, wherein
the nozzle and/or the array of nozzles for depositing the droplets of printing material
the light source for curing the deposited droplets,
the coater for coating the three-dimensional structure and/or
sensor means for controlling the printing process are reversibly or interchangeably fixed to the printing mean. The coater covers the finished three-dimensional structure with a coating, for example a varnish, a polish or a protection coating. It is also thinkable that the coating comprise a color for coloring the three-dimensional structure. It is also conceivable that the coater pre-coats the substrate before the droplets of the printing material are deposited onto the substrate in the first place. The sensor mean controls the printing process and may include elements like a camera, a laser and/or a laser barrier. The nozzle is intended for ejecting the droplets and preferably has a protection device that avoids that light can enter the nozzle. Light that may enter the nozzle could cure droplets before their ejection. A printing mean having interchangeable component may be adapted to the desired condition for the printing process, allows optimizing the printing process with respect to the individual three-dimensional structure and improves thus the quality of the printed three-dimensional structure. Another advantage is that defect components can be replaced easily and fast without replacing the whole printing head.

According to another embodiment of the present invention it is provided that the device for printing a three-dimensional structure comprises a coating device that coats the substrate and/or the three-dimensional structure. In particular it is conceivable that the coating device pre-coats the substrate before the droplets of the printing material are deposited onto the substrate.

Another subject of the present invention is a method for printing a three-dimensional structure using a device as it is described above, wherein the substrate is moved relative to the locally fixed framework.

It is herewith advantageously possible providing a printing method, wherein the movement of the printing mean is restricted and therefor the positioning of the deposited droplets becomes more accurate compared to those known in the state of the art.

According to a preferred embodiment of the present invention it is provided that the three-dimensional structure is printed in a single pass. The single pass corresponds to one pass or scan of the substrate with respect to the substrate. Using such a method for printing has the advantage that the deposition of the droplets does not depend on defects that were made in a previous step of the printing process. For instance it is conceivable that a layer is generated with a vacancy erroneously. The deposited droplets of the next layer may fill the vacancy before the droplets are cured. Consequently the vacancy may keep up and the size of the defect may even grow till the last layer is deposited for forming the three-dimensional structure. As a result the defects may be on the surface of the final three-dimensional structure and reduce therefore the quality of the produces three-dimensional structure disadvantageously. This potential source of error may be circumvented by producing three-dimensional structure in a single pass according to the present invention, advantageously.

According to a preferred embodiment of the present invention it is provided that the droplets of printing material are deposited onto the substrate in a first step and the droplets of the printing material are cured in a second step, wherein the printing head is moved along the printing direction during the first step and wherein the printing head is removed along the direction opposed to the printing direction. In that manner the printing process is accelerated and the efficiency improved since the droplets are deposited and cured by the printing head moving forward and backward only once.

According to a preferred embodiment of the present invention it is provided that in a third step the printing process is observed by the sensor mean, in a forth step the printing process is configured in dependency of the observation made in the third step and in a fifth step the three-dimensional structure is coated. According to this embodiment the printing process the three-dimensional structure is monitored and corrected in a positive manner, whenever the printing process leads to a defect that may impair the quality of the final three-dimensional structure. In particular the coating process according to the fifth step enables manipulating the surface of the three-dimensional structure with respect to its color or other properties.

Another subject of the present invention is a printed article, printed with a method descripted above. The printing article takes advantage of the positive effects of the methods descripted above.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

### BRIEF DESCRIPTION OF THE DRAWINGS

FIG. 1 shows a device for printing a three-dimensional structure according to a first exemplary embodiment.

FIG. 2 shows a profile of a device for a printing a three a three-dimensional structure according to a second exemplary embodiment.

FIGS. 3a. 3b and 3c respectively show snapshots of the device for a printing the three a three-dimensional structure according to the second exemplary embodiment during the printing process, wherein the device is illustrated in a top view.

FIG. 4 show an exemplary printing head used by device for printing a three-dimensional structure according to a third exemplary embodiment.

### DETAILED DESCRIPTION

The present invention will be descripted with respect to particular embodiments and with the reference to certain drawings but the invention is not limited thereto but only by the claims. The drawings described are only schematic and are non-limiting. In the drawings, the size of some elements may be exaggerated and not drawn on scale for illustrative purposes.

Where an indefinite or definite article is used when referring to a singular noun, e. G. “a”,“an”, “the”, this includes a plurals of the noun unless something else is specifically stated.

Furthermore, the terms first, second, third and the like in the description and in the claims are used to distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

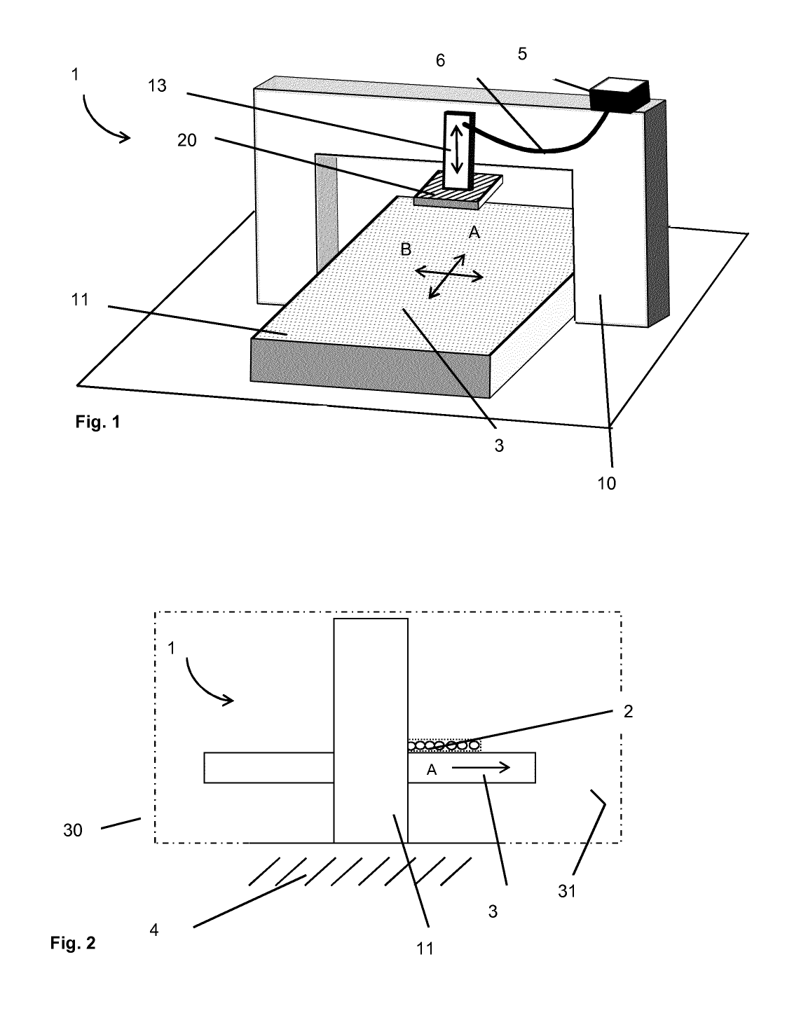

In FIG. 1 a first exemplary embodiment of a device for printing a three-dimensional structure according to the present invention is illustrated. The device 1 is provided for depositing droplets of a printing material onto a substrate 3, wherein the device 1 comprises a locally fixed framework 10 and a mean for moving the substrate 3 relative to the locally fixed framework 10. FIG. 1 shows a locally fixed framework 10 substantially forming an arch, wherein it is provided that the substrate 3 is moved through the arch such that the droplets of printing material can be deposited onto the substrate 3. In such a scenario the arch forms a feedthrough. In order to deposit droplets of printing material the locally fixed framework 10 has a printing head 20 that drops the droplets 70 onto the substrate. Preferably the printing head 20 is connected to a tank 5 or reservoir of printing material integrated in the locally fixed framework such that the printing head gets its printing material form the tank 5 or reservoir of printing material. Thus it is possible that the printing head 20 is supplied by printing material during the whole printing process. Another advantage of integrating the tank 5 to the locally fixed framework 10 is that it is not necessary to move the tank 5 during the printing process. Consequently energy is saved that may be needed for the movement of a heavy tank 5 including the printing material. It is also thinkable that no fluidic pressure valves are needed. Preferably one or more light sources are incorporated in the locally fixed framework 10, wherein it is provided that the light sources, in particular UV-light sources, cure the deposited droplets by illuminating the deposited droplets. Moreover it is provided that the printing head 20 is movable relative to the locally fixed framework, such that the distance between substrate 3 and printing head 20 is changeable. In particular it is possible to reduce the distance between substrate 3 and printing head 20 in order to improve the accuracy of depositing droplets of printing material onto the substrate 3. Such a movement of the printing head 20 relative to the locally fixed framework 10 may be realized by a height adjuster 13. In such a scenario it is conceivable that the printing head 20 and the tank 5 are linked by a flexible innertube 6 in order to guarantee the supply of printing material during the printing process. It is also thinkable that the locally fixed framework 10 is composed of elements such as the tank 5 or a light source for curing the deposited droplets. Such a modular joinable locally fixed framework 10 facilities adapting the locally fixed framework 10 to the respective printing process individually. It is also advantageously possible to replace defect components easily and fast. According to the preset invention it is provided that the substrate 3 is moved relative to the locally fixed framework 10. Preferably the substrate 3 has a main plane and the substrate 3 is moved in a direction parallel to the main plane, wherein the movement of the substrate relative to the locally fixed framework is designated for positioning the droplets onto the substrate and passing the printing head. Preferably the substrate moves mainly along a transport direction A, wherein the transport direction A is directed such that the substrate 3 passes the printing head 20. It is further provided that the substrate 3 is moved along a printing direction B being perpendicular to the transport direction A. The movement along printing direction B causes the form of the three-dimensional structure at least partially, whereas the movement of the substrate 3 along the transport direction A guarantees that the substrate 3 passes the printing head 20. Furthermore it is conceivable that the droplets are deposited during the movement of the substrate and/or the deposited after a movement of the substrate. In order to move the substrate 3 the device comprises a mean for moving the substrate 11. According to the first exemplary embodiment the mean for moving the substrate comprises a plate, wherein the substrate is arranged on top of the plate. Such a plate may comprise vacuum micropores and/or a ceramic plate. It is conceivable that the plate includes also devices for moving the substrate controllably such as roller or guide rails. Further it is thinkable that the substrate is moved direct or indirectly by the means for moving the substrate 11 or that the substrate 3 is integrated in the mean for moving the substrate, wherein the three-dimensional structure 3 is removed from the substrate after the printing process and the substrate 3 is reused subsequently for the next printing process. It is also conceivable that the substrate 3 is part of the three-dimensional structure 2 and the mean for moving the substrate 11 is adapted to the shape of the substrate 11. Preferable the three-dimensional structure is printed in a single pass, i. e. the substrate passes the printing head only once during the printing process.

In FIG. 2 a side view of a second exemplary embodiment of a device for printing a three-dimensional structure according to the present invention is illustrated. It is provided that the substrate 3 is moved along the transport direction A. As a result of the movement of the substrate 3 and the deposing of the droplets onto the substrate the three-dimensional structure 2 is generated formed by the deposited droplets. Preferably the locally fixed framework 10 is directly connected to a floor 4. In particular it is provided that the mean for moving the substrate 3 is attached to the locally fixed framework 10 and guarantees that the substrate 3 passes the printing head 20. Moreover it is further provided that the movement of the substrate 3 is restricted to the transport direction B and the positioning of the droplets may be realized by nozzles of the printing head 20. For this purpose the printing head 20 is configured such that nozzles may eject droplets of printing material individually and in dependence of the position of the substrate 3 with respect to the printing head 20 and/or the printing head is movable in the printing direction B. Preferably the printing direction B is perpendicular to the transport direction and parallel to the main plane of the substrate 3. In particular it is provided that the device 1 for printing the three-dimensional structure is surrounded by an encapsulation 30 at least partially. According to the second embodiment illustrated in FIG. 2 the device for printing the three-dimensional structure 11 is surrounded by an encapsulation completely. In such a scenario it is possible to realize a cleanroom for the device 1 for printing the three-dimensional structure. The encapsulation is configured such that the inside of the encapsulation is isolated from the environment surrounding the device for printing material. Moreover it is also thinkable to realize a cleanroom that is fillable with a gas, in particular a gas that improves the curing process. In particular the dosage of the gas is adapted for optimizing the curing process individually. In some cases it may helpful to realize a specific pressure inside the cleanroom in order to optimize the printing process. Further it is preferably provided that the encapsulation 30 is configured such that light cannot transmit through the encapsulation. As a result the light intended for curing the droplets stays within the printing head encapsulation 30 and cannot interfere with the surroundings of the encapsulation 30 negatively. Without the encapsulation the light, in particular UV-light, may damage items or persons, whenever light is reflected or scattered from the device 10 to those items or persons. Consequently the encapsulation 30 realizes a safety device advantageously. For the purpose of blocking light at least one surface of the encapsulation 30 facing the device for printing a three-dimensional structure is coated using a coating 31. In particular the coating 31 is a UV grade coating. Moreover it is also thinkable that the coating 31 is realized such that the light is reflected or scattered to the droplets deposited on the substrate 3 and therefore supports the curing process consequently

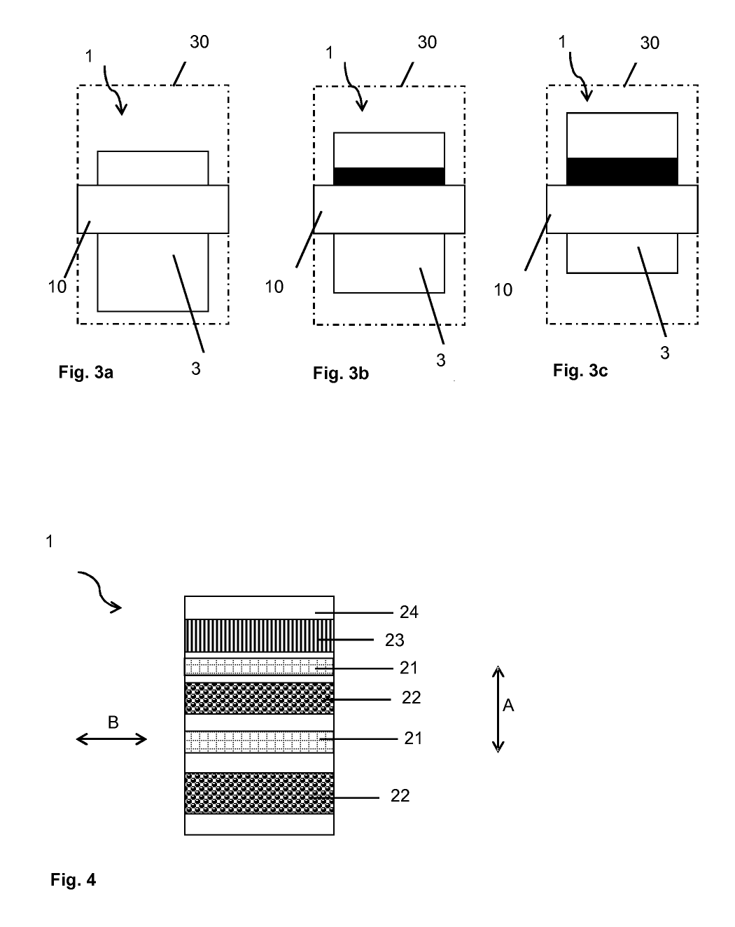

FIGS. 3a, 3b and 3c illustrate snapshots of the device for a printing the three a three-dimensional structure according to the second exemplary embodiment during the printing process, wherein the device is illustrated in a top view. FIG. 3a shows the device 1 for printing a three-dimensional structure and the substrate 3 at that time the printing process starts and no three-dimensional structure 2 is observable. Subsequently the droplets are deposited on the substrate 3 and the substrate 3 is moved along the transport direction A. As a result a three-dimensional structure is observable in FIG. 3b. The three-dimensional structure 1 continues growing further in a direction parallel to the transport direction A as it is show in the snapshot of the printing process in FIG. 3c. Preferably the printing process is finished after the substrate 3 completely passed the printing mean 20 for the first time. In such a scenario the three-dimensional structure 3 grows in a direction perpendicular to the printing direction B and parallel to the transport direction A.

In FIG. 4 a top view of an exemplary printing mean 20 of a device 1 for printing a three-dimensional structure according to the present invention is illustrated. More precisely the side of the print mean 20 facing the substrate 3 during the printing process is shown. It is provided that the printing mean 20 comprises components, wherein each component is removable and/or replaceable individually, i.e. the components are modular. In particular the components differ from each other. For example a printing mean 20 may have the following modular or interchangeable components:
component comprising a nozzle and/or an array of nozzles for ejecting droplets of printing material, i.e. a printing head,
component comprising a light source, in particular a UV-light source, for curing the deposited droplets
component comprising a coater 24 for coating the three-dimensional structure 2 and/or
component comprising sensor means 23 for observing the printing process. Preferably it is provided that a body of the printing mean 20 has means for adapting the several components individually. Moreover it is provided that the components are attached to the body of the printing mean 20 such that at least a nozzle and a light source are arranged one after the other in a direction parallel to the transport direction B. Thus it is possible to deposit droplets and subsequently cure the deposited droplets. It is further thinkable that the printing mean 20 is moved along the printing direction B in a first step of printing the three-dimensional structure 2 and returns along the opposite direction is a second step of printing the three-dimensional structure, wherein droplets of printing material are deposited onto the substrate during the first step and the deposited droplets are cured by illumination during the second step.

### REFERENCE SIGNS

1 device for printing a three-dimensional structure
2 three-dimensional structure
4 floor
3 substrate
5 tank
6 innertube
10 locally fixed framework
11 a mean for moving the substrate
13 height adjuster
20 printing mean
21 light source
22 nozzles
23 sensor means
24 coater
30 encapsulation
31 coating of the encapsulation
A transport direction
B printing direction

1. A device for printing a three-dimensional structure by depositing droplets of printing material onto a substrate, wherein the device for printing the three-dimensional structure comprises a locally fixed framework and a mean for moving the substrate, wherein the locally fixed framework comprises a printing mean for depositing the droplets onto the substrate and the mean for moving the substrate is configured such that the substrate is movable relative to the locally fixed framework.

2. The device according to claim 1, wherein the substrate has a main plane and the mean for moving the substrate is configured such that the substrate is movable:
a) in a transport direction for passing the printing mean and/or
b) in a printing direction for realizing at least a part of the three-dimensional structure,
wherein the transport direction and the printing direction are parallel to the main plane.

3. The device according to claim 1, wherein the printing mean is arranged to the locally fixed framework such that the distance between the substrate and the printing mean is variable.

4. The device according to claim 1, wherein the mean for moving the substrate and/or the printing mean are configured such that the mean for moving the substrate and/or the printing mean causes the positioning of the droplets deposited onto the substrate.

5. The device according to claim 1, wherein the locally fixed framework comprises a tank including printing material, wherein the tank is configured such that the tank supplies the printing mean with printing material and wherein the tank is connected interchangeably to the locally fixed framework and/or wherein the fixed framework comprises a premix chamber.

6. The device according to claim 1, wherein the locally fixed framework comprises a light source for curing the deposited droplets of printing material, wherein the light source is connected interchangeably to the locally fixed framework.

7. The device according to claim 1, wherein the mean for moving the substrate is attached to the locally fixed framework.

8. The device according to claim 1, wherein the device comprises an encapsulation wherein the encapsulation surrounds at least a part of the locally fixed framework, the means for moving the substrate and/or the substrate, wherein the encapsulation is configured such that light is blocked by the encapsulation.

9. The device according to claim 8, wherein the encapsulation forms a cleanroom including the substrate, the locally fixed framework and the means for moving the substrate.

10. The device according to claim 1, wherein the printing mean comprises:
a) a nozzle and/or an array of nozzles for depositing the droplets of printing material,
b) a light source for curing the deposited droplets,
c) a coater for coating the three-dimensional structure and/or
d) sensor means for controlling the printing process;
and wherein:
the nozzle and/or the array of nozzles for depositing the droplets of printing material;
the light source for curing the deposited droplets;
the coater for coating the three-dimensional structure; and/or
the sensor means for controlling the printing process are interchangeably fixed to the printing mean.

11. A method for printing a three-dimensional structure using the device according to claim 1, wherein the substrate is moved relative to the locally fixed framework.

12. The method according to claim 11, wherein the three-dimensional structure is printed in a single pass of the substrate relative to the printing mean.

13. The method according to claim 11, wherein the droplets of printing material are deposited onto the substrate in a first step and the droplets of the printing material are cured in a second step, wherein the printing mean is moved along a printing direction during the first step and wherein the printing mean is removed along a direction opposed to the printing direction.

14. The method according to claim 13, wherein in a third step the printing process is observed by a sensor mean, in a forth step the printing process is configured in dependency of the observation made in the third step and in a fifth step the three-dimensional structure is coated.

15. A printed article produced by the method according to claim 11.

16. A printed article produced by the method according to claim 14.
